(19) United States
(12) Patent Application Publication
(10) Pub. No.: US 2002/0103740 A1
(43) Pub. Date: Aug. 1, 2002

(54) System and method facilitating multilateral and bilateral negotiations

(75) Inventor: Christopher Maroney, Toms River, NJ (US)

Correspondence Address: HOGAN & HARTSON L.L.P., 500 S. GRAND AVENUE, SUITE 1900, LOS ANGELES, CA, 90071-2611, US

(73) Assignee: Register.com, Inc.

(21) Appl. No.: 09/773,183

(22) Filed: Jan. 30, 2001

(51) Int. Cl. G06F 17/60

(52) U.S. Cl. 705/37

(57) ABSTRACT

Domain names are transferred in a two-stage process. The first stage of the process is a public auction conducted on a web server, with the bidders accessing the auction website over the Internet. When the auction does not result in a transfer of the registration, for example when the auction has a reserve that is not met, the transaction proceeds into a second, private stage. The auction server invites the high bidder from the auction to participate in a first bilateral negotiation, preferably by sending e-mail including the URL for a negotiation website. Should this first private negotiation not result in a transfer, then another bidder from the auction is invited to participate in a second bilateral negotiation. This process continues until a transfer completes successfully or the offering party withdraws the domain name from the market.

### BACKGROUND OF THE INVENTION

1. Field of the Invention

The present invention relates generally to a mechanism and method whereby a first type of exchange negotiation open to multiple parties such as an auction can be translated to a second type of exchange negotiation such as a bilateral negotiation in which details of the negotiation are private between the parties. Specific implementations of aspects of the present invention may be mediated over long distances and might, for example, advantageously communicate across the Internet using a combination of automated messaging, such as e-mail, and individualized interactions on remote forum such as on a website.

2. Description of the Related Art

Domain names and the registrations to use those domain names are valuable and there is a natural desire to acquire domain names that are appropriate to a business or that are otherwise desirable to an individual. There is a concomitant and equally natural desire for individuals or organizations to obtain value for domain name registrations that are no longer of value to the holder. Because of this, there has been considerable activity both in the original or initial registration of domain names and in the post-registration transfer of domain names. As distinctly intangible rights, the trading or transfer of domain names is well suited to auctions mediated over the Internet. A number of organizations have arisen to facilitate and conduct auctions presently including Afternic.com.

Generally these auctions are conducted on a website and identify the right being offered, a history of bids including the current bid, identification of bidders usually in the form of a screen name, and a clock indicating the amount of time remaining in the auction. Auction sites can be implemented in a number of known manners using conventional database and web server strategies. The auction site generally provides a search engine that assists in identifying auctions of interest. Bids are submitted to the auction site by interested bidders that are either registered with the site or that are otherwise authenticated by the auction site. Auctions continue for a predetermined amount of time that can be set according to the auction site's or the domain name registration owner's preference. As with other types of auctions, an auction of a domain name registration can be subject to a reserve price that must be met if the auction is to complete successfully.

When the auction completes successfully, an announcement is made that the auction is complete and has resulted in an agreement to transfer. This announcement may be in the form of a posting on the relevant page of the auction's website, may be in the form of automatically generated e-mails to participants, or a combination of these strategies. If the auction is unsuccessful, no transfer is made and a new auction for the name may begin. Subsequent auctions can be useful when new interested bidders find the auction or as an overall strategy for a registration holder.

Auctions are not wholly satisfactory for the transfer of domain name registrations. The following description of preferred embodiments presents certain modifications or alternatives to auctions for the transfer of domain name registrations. To provide a background for that discussion, the following provides an overview of the present characteristics of domain names, how domain names are registered, and what needs to be done to make a registration effective.

Each computer on the Internet is identified by a unique Internet protocol (“IP”) address. This address is a 32-bit number organized as four 8-bit values separated by periods such as 123.45.67.89. Such a numerical system, while useful as a routing address system for computer-to-computer communication, is not human user-friendly. Consequently, domain names are used to allow users to more easily identify and connect to a target computer on the network. These user-friendly domain names (or “host names”), such as “afternic.com”, are easy for users to remember and, since they map to a unique IP number, accurately identify the computer's IP address. In such a domain name identification scheme, the domain name forms a part of the uniform resource locator (URL) that specifies the location of resources on the World Wide Web. The URL identifies the mechanism used to access the resource (e.g., http, ftp, etc.), the specific computer that houses the resource, and the specific name of the resource (such as a filename).

As with the underlying Internet address, domain names typically have a hierarchical organization, with the trailing portion of the domain name, such as .com, net, org, us, .uk or jp, representing the top-level domain. Top-level domains include global top-level domains (gTLD) and country specific or country code top-level domains (ccTLD). The global top-level domains include .com, .org, net, .edu, .gov and .mil. Of these, .edu, .gov and .mil gTLD's are restricted to use by entities meeting specific qualifications. Other global top level domains have been introduced and can be expected in coming years. Country code top-level domains are country specific in that they identify registrations within a given country. The specific country governs registration for the country code top-level domains. Some countries are “open” in that they allow any entity to register a domain name within its ccTLD. Other countries are “closed” and only allow entities that meet restrictions such as residency to register domain names in that ccTLD. Most domain users presently use one or more of the .com, net or .org gTLDs.

The domain name entered by a user is sent over the Internet to a global network of servers called the “domain name system” (DNS), which receives the domain name as a request and translates the domain name into the target computer's numerical IP address. The numerical IP address is returned to the user's computer to enable it to connect to the target computer. Typically, after the user enters the domain name, the rest of the process is invisible to the user until the user connects to the target computer. The domain name system consists of a collection of root servers or DNS Servers that provide a directory linking domain names with corresponding IP addresses. There are presently thirteen root servers worldwide that contain authoritative databases or “root zone files” listing all top-level domains. The collection of root servers is centrally managed for all global top-level domains to ensure that each computer on the network can be uniquely identified by unique domain names and numerical addresses.

A “registry” is an international organization or entity that is responsible for assigning domain names and Internet protocol addresses. Each country maintains its own registry, generally through a company or organization. The registry has the responsibility to record and update domain names and Internet protocol addresses, as well as the information associated with them, on the root servers. A registry is under contract from its respective government to control domain name registration. The registry may authorize other entities, known here as registrars, to conduct domain name registration and other aspects of the management of domain names and IP addresses.

A “registrar” is an organization or company that is authorized to provide registration services for all users of certain top-level domains, such as the net, .org and .com global top-level domains. Registrars are presently authorized either by ICANN, the Internet Corporation for Assigned Names & Numbers, a U.S. governmental organization under the Department of Commerce, or by the registrar's respective government to control domain name registration. A registrar is authorized by the registry to act as an agent of the registrar to process domain name registration. The registrar has the responsibility to create and maintain a Whois database and zone files for its customers. Examples of registrars presently include Register.com and Network Solutions, Inc., both authorized by ICANN.

A “registrant” is the individual or organization to whom a specific domain name is registered with the registry. Once a registrant has registered a domain name, paid the associated fees and met certain conditions, the individual or organization holds the domain name for use for a specific period of time. The registrant can use the domain name for such purposes as web hosting and e-mail. In many cases, the registrant may incorporate one or more domain names into an organizational identity or business. As such, a registration to use a particular domain name can be viewed as a significant asset for certain registrants.

The “shared registry system” (SRS) is a system that permits multiple registrars to provide registration services for the .com, .net and org domains and such other top level domains as become available for commercial or public use. The system is a shared database that holds information about domain names and their authoritative name servers. The shared registry system updates the root zone file within the root servers with information about the domain names for the .com, org and .net gTLDs about every twenty-four hours in typical operation. The SRS allows accredited registrars to enter information about newly registered domain names into the SRS, and the information about the-newly registered domain names is then uploaded to the root servers. Accredited registrars can update name server information within the SRS for domain names for which they are recognized as registrar. Accredited registrars are registered with the SRS and access the SRS through a secure and authenticated communication channel, such as through a secure socket level encrypted communication link. The SRS facilitates the updating of domain name and IP address information and also provides a utility for identifying the registrar that registered a domain name, when the entry to the SRS was created and the authoritative name servers for the domain name.

Domain names may be registered initially either by an accredited registrar or by an unaccredited registrar that cooperates with an accredited registrar to effect the registration of a domain name. For a domain name registration to be fully effective, the association between the domain name and the corresponding IP address needs to be recorded in the registry and recorded in the DNS servers. Transfers of domain name registrations require that the domain name be associated with a new IP address and that association recorded and updated throughout the registry and the DNS servers.

### SUMMARY OF THE PREFERRED EMBODIMENTS

An aspect of the present invention provides a system facilitating transfer of an asset in a private negotiation following a public negotiation, including a transaction controller. The transaction controller identifies at least one participant for a private negotiation from a set of participants from a public negotiation in which one or more participants negotiated for purchase of an asset. A message generator is coupled to the transaction controller and forwards a message to the at least one participant for the private negotiation inviting the at least one participant to engage in a private negotiation for the purchase of the asset. A server outputs information to the at least one participant representative of at least an identification of the asset, an identification of a party offering the asset, an identification of the at least one participant and a current offer or bid price for the asset. The server outputs the information in response to the transaction controller indicating that the at least one participant will participate in the private negotiation.

Another aspect of the present invention provides a system facilitating transfer of an asset in a sequence including at least one private negotiation following an auction. A first computer is adapted to connect through a network to at least one server, the server accessing and serving auction data representative of an auction for an asset and at least a first state of a first bilateral negotiation for the intangible asset. Preferably, the first state identifies a seller and a first bidder from the auction engaged in the first bilateral negotiation. The first computer receives messages directed to the first bidder in the bilateral negotiation, including a first message inviting the first bidder to engage in the first bilateral negotiation. Upon the first bidder initiating the first bilateral negotiation, the first computer receives the first state of the first bilateral negotiation and generating a first screen illustrating a present state of the first bilateral negotiation.

### BRIEF DESCRIPTION OF THE DRAWINGS

Preferred aspects of the present invention are described herein with reference to the following views of the drawings, which form a part of the present disclosure.

FIG. 1 schematically illustrates a series of private stage, bilateral negotiations that might proceed in accordance with aspects of the present invention.

FIG. 2 illustrates aspects of the computer systems used and accessed in accordance with preferred embodiments of the present invention.

FIG. 3 schematically illustrates aspects of a negotiation website generated and used in practice of aspects of the present invention.

### DETAILED DESCRIPTION OF THE PREFERRED EMBODIMENTS

Particularly preferred embodiments of the present invention provide a mechanism and method facilitating the transfer of a domain name from a domain name registrant to a party that wishes to purchase the registration for the domain name. Generally the transaction may proceed through two stages, a public stage and a private stage. The public stage of the transaction might be an auction. The auction might not be successful, so that no domain name registration transfer results. Following an unsuccessful public stage of the transaction, the party offering the domain name and one of the participants in the public stage of the transaction are invited to participate in a private stage of the transaction. The private stage of the transaction might be a bilateral negotiation. Should this first private stage negotiation not result in a transfer, then the seller and another participant in the public stage of the transaction may be invited to participate in a second private stage negotiation within the transaction. This process can continue until a transfer completes successfully or the offering party withdraws the domain name from the market. In the alternative, an additional public stage of a transaction with the potential for a private stage of the transaction might be initiated.

The public stage of a preferred domain name transaction may take the form of an auction in which the domain name being offered is identified along with the current bid, the bidding history and the time remaining in the auction. Under some public auction rules, when the offering party puts a registration up for sale by auction, the offering party is obligated to accept the final bid in the auction and transfer the domain name to the winning bidder. In other types of auctions, it is possible for the auction to end and not transfer of the domain name. This might occur, for example, when the public stage of the transaction is a reserve auction. In reserve auctions, the offering party sets a minimum final bid at which the auction will be successful. If the highest bid at the close of the auction period is below the reserve price, then the offering party can decline to accept the highest bid. In such a case, the auction does not result in a transfer of the domain name registration.

According to preferred aspects of this invention, when the public stage of the transaction fails to produce a transfer, a set of the parties to the public stage of the transaction may be invited to participate in a private stage of the transaction. For example, the offering party and the highest bidder at the end of the public stage of the transaction may be invited to participate in a private stage of the transaction. The private stage transaction is preferably a bilateral negotiation. Within such a preferred bilateral negotiation, the invited parties exchange offer to buy and offer to sell bids until either the bid or sell price is accepted, the negotiation period comes to an end, or one or both of the parties withdraw from the negotiations. If the first of the private stage negotiations does not result in a transfer, then a second private stage negotiation might be initiated by, for example, asking a new bidder from the public stage transaction to participate in a second private stage transaction. A series of private stage transactions may proceed until the registration is transferred, no more bidding parties are available from the public stage of the transaction or the offering party no longer wishes to continue with negotiations.

It should be appreciated that the offering party need not explicitly agree to enter the private stage or stages of the transactions at the beginning of the private stage or stages. Rather, the offering party might agree during the set up of the public stage of the transaction period to pursue one or more private stage transactions should the public stage transaction not result in a transfer. In addition, if the offering party has agreed to a private stage transaction, the system or method may presume that the offering party will engage in the next private stage negotiation and provide a mechanism for the offering party to opt out of a next private stage negotiation. There are advantages to each of these strategies. On the other hand, it is generally most advantageous to invite each bidding party to negotiate within a particular private stage negotiation separately before that negotiation. There may be a notification to each of the bidding parties that has not yet been a party to a private stage negotiation that such negotiations are ongoing. Such a notification is useful to maintain interest in the possibility of purchasing a domain name registration by parties that are not actively participating in the current private stage negotiation.

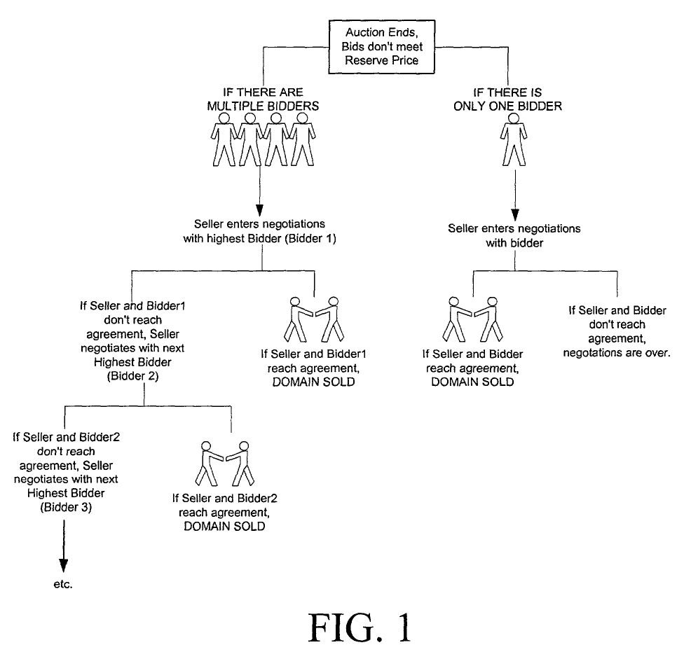

It should be appreciated that the availability of a second, private stage of negotiations following an unsuccessful public auction can significantly alter the conduct of the auction. To ensure that the availability of a second stage of negotiations facilitates the transfer of domain name registrations, it is preferred that priority for admission to the second stage of negotiations be awarded by rank ordering the participants in the auction by the value of their final bid. Thus, the participant having the highest final bid at the close of the auction is preferably the first invited to enter a bilateral negotiation with the domain name registrant. This encourages parties to offer more to be the highest bidder at the close of the auction. FIG. 1 illustrates schematically the progress of a series of post auction negotiations using the preferred method of rank ordering prospective participants in a negotiation on the basis of the value of the participants' final bid in a domain name registration auction.

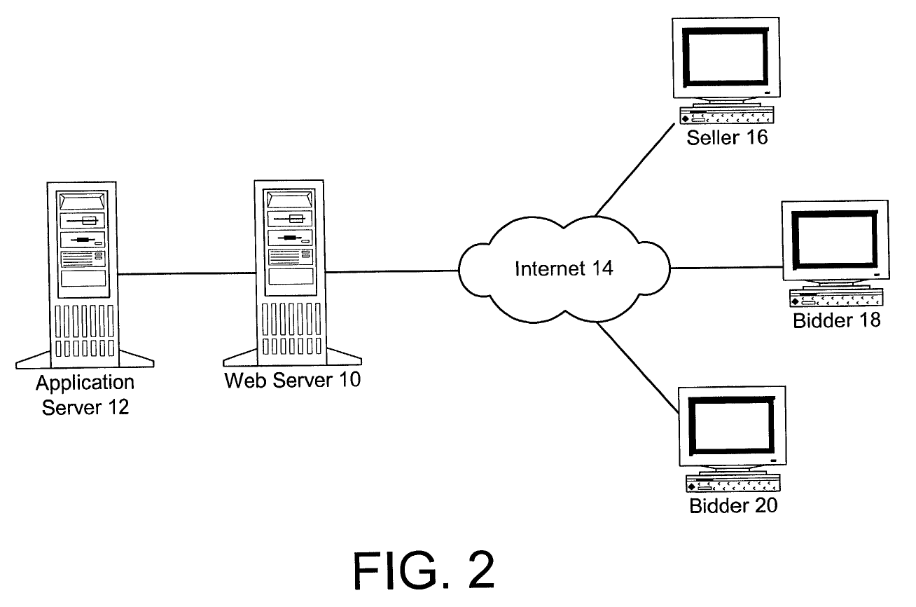

FIG. 2 schematically illustrates a computer system that may accommodate both the auction of the domain name registration and a subsequent series of bilateral negotiations between the domain name registrant and bidders from the auction. In the system illustrated in FIG. 2, a web server 10 performs the primary functions of conducting an auction, facilitating bilateral negotiations and accessing the resources used by these functions. The web server provides a messaging facility for receiving messages from a medium such as the Internet and processing these messages. Typically a message will request access to information or a resource and the messaging facility provides this capability in the illustrated embodiment. The messaging facility gathers requested information and outputs the gathered information in a form that, in preferred aspects of the present invention, populate or serve one or more screens illustrative of different functions of an auction and bilateral negotiation website. The messaging facility preferably also communicates more individually by generating e-mail messages, for example, to invite participation in a bilateral negotiation.

Most preferably, the web server also includes transaction management logic capable of managing an auction, identifying a series of participants in a corresponding series of bilateral negotiations from the bidders in an auction, and otherwise managing the decisions and logic involved in practice of preferred aspects of the present invention. Those of ordinary skill in this art will recognize that the transaction management logic may be embodied in the rules of a database or in macro functionality associated with a database. Other implementations are well understood. The web server 10 is preferably coupled to an application server 12 via a network, such as a high-speed variant of an Ethernet network. The application server may provide storage or may in fact provide the logic and functionality of the transaction management logic. As will be apparent to those of skill in this art, the various resources discussed here can be configured differently and the web server and the application server may in fact be within the same server hardware.

The web server 10 receives messages from the Internet 14 and serves information to a plurality of browsers 16, 18, 20 over the Internet 14. The various illustrated browsers are provided on individual computers of, for example, of a domain name registration seller 16 and first and second bidders 18, 20 in an auction that will subsequently participate in respective first and second bilateral, private-stage negotiations.

The auction stage of a domain name registration transaction can be illustrated with reference to FIG. 2. A first bidder, using a browser 18, requests access to the web server 10 over the Internet 14. The browser requests an auction web page from the web server using, for example, a message in a format such as the hypertext transfer protocol (HTTP). The message enters web server 10. The web server 10 parses the message and, as appropriate, either serves the requested information or requests the information from the application server 12 to respond in whole or in part to the request. Static web pages are generally served from the web server 10, while requests for dynamic content might require requests to the application server 12, depending on the configuration of the system. The requested auction web page is then sent out to the waiting browser 18.

To sign up for an auction on a web auction site either as a seller or a bidder, a user is required to register with the auction site. Typically, the user is required to submit identifying information such as, name, e-mail address, physical address, credit card information, etc. Moreover, the user agrees to the terms set by the auction site as a condition of the registration process. For the auction of a domain name, the registration holder might be required to identify the administrative contact for the domain name or otherwise show ownership of the registration. As security for the bidder and seller, the auction site preferably provides an escrow facility that allows for payment for the domain name to be held by a third party until the domain name is transferred.

Generally the auction web page is identified in a search engine within the auction site and might additionally be registered with other search engines to facilitate identification of the auction web page. The auction web page is preferably open to the public in this part of the transaction, that is, anyone can visit and view the web page throughout the duration of the auction. The site displays most information provided by the seller except for identifying information submitted for security reasons. The reserve price may or may not be displayed at the seller's choice. In addition to the information provided by the seller, the site may display information useful to the auction, such as the highest bid at a particular point in time, time remaining for the auction, bid increment, etc.

When a predetermined time for a domain name auction subject to reserve ends and the highest bidding price is equal to or greater than the reserve, the seller becomes bound to sell and the bidder becomes bound to purchase the property. The auction site provider contacts both the seller and the bidder, typically through e-mail, and provides each of the parties a facility through which to communicate and complete the transaction. The transaction is preferably completed through access to an escrow facility and other aspects of the post auction closing are conventional.

If the predetermined time for the domain name auction with reserve ends with no bid meeting the reserve, the auction may proceed into a second, private negotiation session, known here as “overtime.”

Preferred implementations of the present invention provide a web site that provides a domain name registration seller and one or more bidders an option to conduct a post-auction negotiation. If no bidding price meets the reserve at the end of the auction, the preferred auction site automatically notifies, preferably electronically, the registrant and the bidders that a space has been created in which the registrant and a selected bidder may conduct a bilateral negotiation. Preferably the notification is from a message generator within the web server 10. Either the registration seller or the selected bidder may choose not to enter into the negotiation. If the registration seller elects not to negotiate, the negotiation space is eliminated from the auction site. If the selected bidder elects not to negotiate, another bidder is selected and invited to conduct a bilateral negotiation with the domain name registration holder.

If both parties elect to participate, the auction web server 10 maintains the space open for a predetermined time period or until an agreement is reached. Most preferably, this portion of the web site is secure and the seller and selected bidder are provided access to the secure web site. Access might be provided in part by forwarding the seller and the bidder a URL for the negotiation web page. Access to the web page may be limited according to the user name and password used to secure the auction site as a whole. If, after the negotiation session, an agreement is reached between the parties, then the parties are bound to the terms of the agreement and the remainder of the transfer proceeds in the conventional manner. If no agreement is reached, the bidder is exited from the space at the end of the predetermined time and another bidder is notified, preferably electronically, that the space has become available for a bilateral negotiation. Either party may also exit negotiations before the predetermined time expires. This cycle continues until the registrant and a bidder reach an agreement or the predetermined time period for the lastly selected bidder ends. The order of negotiation among the bidders is preferably predetermined in accordance with the ending bidding prices.

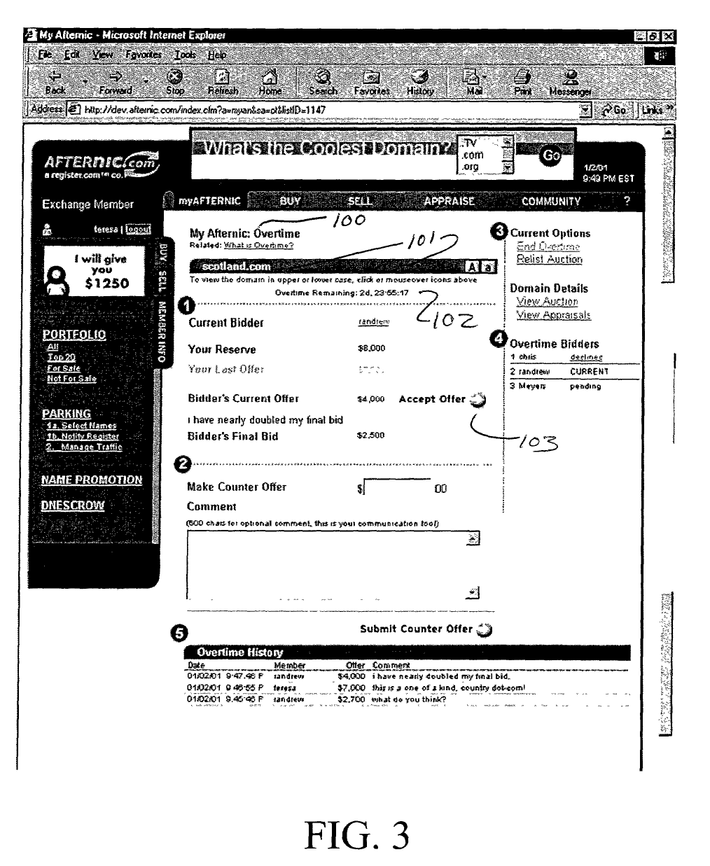

A particularly preferred embodiment of the present invention is described in detail in reference to FIG. 3. FIG. 3 illustrates a screen or web page from the domain name auction website that facilitates a bilateral post-auction negotiation. “Overtime” takes place if, after the public auction period for the domain name registration transaction, no bid is equal to or greater than the reserve price for the auction. As the first stage of “overtime,” the registration seller and all bidders receive an e-mail message indicating commencement of a bilateral post-negotiation phase, or “overtime.” During “overtime,” the registrant and a first selected bidder are provided access to the “overtime” web page on the auction site, marked as “overtime” 100. The “overtime” web page facilitates negotiations by the registrant and the selected bidder over the transfer of the subject domain name displayed in a highlighted box 101. In FIG. 2 embodiment, the subject domain name is “scotland.com”.

The order of access to the bilateral negotiation web pages preferably is determined by the bids at the end of the auction. A bidder with the highest final bid after auction preferably becomes the first bidder to gain access, and a bidder who has the second highest bidding price becomes the second bidder to gain access, and so on. If there is only one bidder, the bidder automatically gains access to the post-auction negotiation space upon accepting overtime.

The seller and the first bidder gain access at the end of the auction on commencement of “overtime.” The automatic email messages sent at the end of the auction to the seller and the first bidder preferably contain links that direct them to the negotiation space. E-mail messages sent to other bidders at the end of the auction, on the hand, preferably do not contain links to the negotiation space.

The negotiation web page displays a countdown clock 102 indicating an amount of time remaining for a registrant-bidder pair currently in session. Each registrant-bidder pair is allotted a predetermined time period to negotiate. If, for example, the registrant and the first bidder reached no agreement at the end of the predetermined time period, the first bidder is automatically denied access from that point in time. At the same time, the second bidder receives an e-mail message from the web site provider, the e-mail message containing links that direct the second bidder to the negotiation space. This cycle continues until the last bidder receives an e-mail message containing links that direct him to the negotiation space.

A section immediately below the countdown clock 102 contains a summary of the negotiation activity. The summary section 1 includes the bidding party's username, the seller's reserve price, seller's last offer and comments, bidder's last offer and comments, and bidder's bidding price at the end of the auction. The summary section 1 viewed by the registrant may differ from that displayed to the bidder. The summary section viewed by the bidder may not, for example, display the registrant's reserve price if the registrant elects not to display it.

An offer by each party binds the offering party during the negotiation period until the other party makes a counteroffer. As long as there is a standing offer, the other party may accept the offer by clicking on an “Accept Offer” button 103 located in the summary section. FIG. 3, for example, illustrates the summary section 1 viewed by the registrant after the bidder made an offer. If the registrant clicks on the Accept Offer button 103, the registrant becomes bound to transfer the domain name to the bidder and the bidder becomes bound to pay the offer price in exchange of receiving the domain name.

If one party makes an offer that is unsatisfactory, the other party may decline to accept the offer by making a counteroffer in a counteroffer section 2, the section below the summary section 1. The party can also attach comments to the counteroffer in this section. The counteroffer is submitted if a “Submit Counter Offer” button found at the bottom of the counteroffer section 2. The counteroffer relieves the party who made the previous offer from being bound to the previous offer, and binds the new offeror to the counteroffer.

A current options section 3 on top of the right column of the screen in FIG. 3 lists options for the party viewing the screen. The list may consist of two options or one option depending on the viewer of the screen. The registrant is provided an option to “end overtime” or to “relist auction”, whereas a bidder is provided an option to “exit or decline overtime”. If the registrant elects to end overtime, all negotiations with all bidders are cancelled. If the registrant elects to relist auction, all negotiations with all bidders are cancelled and the registrant can register for a new auction. If a bidder elects to exit or decline overtime, the negotiation between the registrant and that bidder is cancelled and the negotiation space becomes available for the registrant and the next highest bidder. In all these cases in which one party elects to terminate negotiation, all participants of the auction preferably are notified electronically.

Below the current options section 3 is a bidder's list section 4 that displays a list of all bidders' statuses, only viewable to the seller. FIG. 3 shows that the second bidder is current in a session with the registrant, while the first bidder has declined to negotiate with the registrant and the third bidder is waiting for his turn. On the bottom of the screen, a list shows a history of the negotiation session appears in overtime history section 5. The list contains offers made by the parties of the negotiation in a chronological sequence.

Viewing the web site containing the sections described above and interacting with a another party via the Internet, a user is able to participate in an auction and a bilateral post-auction negotiation. The present invention improves the chances of more transactions being successfully completed by providing a post-auction negotiation space. In a classical auction with reserve situation, the registrant is not provided an option to lower its reserve price, even if the registrant would have preferred to transfer the domain name at the price given at the auction, rather than not transferring or resubmitting another auction. This post-negotiation space provides the registrant an opportunity to do that. Moreover, unlike a classical auction situation, a bidder in a bilateral post-auction negotiation receives feedback from the registrant, allowing the bidder to obtain a better feel for his chances. The seller can now also use the reserve price as a strategic point, a ceiling from which to negotiate down, instead of the traditional meaning of reserve price as the price the seller will accept.

While the present invention has been described with reference to a most preferred embodiment thereof, those of ordinary skill in the art will appreciate that various modifications and extensions might be made to the present invention without varying from its basic teachings. As such, those of ordinary skill in the art will appreciate that the present invention is not to be limited to the most preferred embodiment described herein. Rather, the scope and content of the present invention is to be determined from the claims, which follow.

What is claimed:

1. A system facilitating transfer of an asset in a private negotiation following a public negotiation, the system including:
a transaction controller identifying at least one participant for a private negotiation from a set of participants from a public negotiation in which one or more participants negotiated for purchase of an asset; and
a message generator coupled to the transaction controller, the message generator forwarding a message to the at least one participant for the private negotiation inviting the at least one participant to engage in a private negotiation for the purchase of the asset,
the message generator outputting information to the at least one participant representative of at least an identification of the asset, an identification of a party offering the asset, an identification of the at least one participant and a current offer or bid price for the asset, the server outputting the information in response to the transaction controller indicating that the at least one participant will participate in the private negotiation.

2. The system of claim 1, wherein the asset is a domain name registration.

3. The system of claim 2, wherein the transaction controller receives a message indicating termination of a first private negotiation in which the asset was not transferred and subsequently identifies a second participant for a second private negotiation and causes the message generator to forward a message to the second participant for the second private negotiation,
wherein the transaction controller receives a message indicated that the second participant will engage in the second private negotiation and the transaction controller causes the message generator to output information to the second participant representative of at least an identification of the asset, an identification of a party offering the asset, an identification of the at least one participant and a current offer or bid price for the asset.

4. The system of claim 3, wherein the transaction controller identifies the at least one participant and the second participant from a rank ordering of participants in the public negotiation, the rank ordering based on final bid of the participants in the public negotiation.

5. The system of claim 1, wherein the transaction controller identifies a first and second participant for a first and a subsequent private negotiation, respectively, from a rank ordering of participants in the public negotiation, the rank ordering based on final bids of the participants in the public negotiation, with a highest final bid identifying the first participant in the first private negotiation.

6. A system facilitating transfer of an asset in a sequence including at least one private negotiation following a multilateral negotiation, the system including:
a first computer adapted to connect through a network to at least one server, the server accessing and serving data representative of a multilateral negotiation for an asset and at least a first state of a first bilateral negotiation for the asset, the first state identifying a seller and a first bidder from the multilateral negotiation to engage in the first bilateral negotiation,
the first computer receiving messages directed to the first bidder in the bilateral negotiation, including a first message inviting the first bidder to engage in the first bilateral negotiation,
wherein, upon the first bidder initiating the first bilateral negotiation, the first computer receiving the first state of the first bilateral negotiation and generating a first screen illustrating a present state of the first bilateral negotiation.

7. The system of claim 6, wherein the multilateral negotiation is an auction.

8. The system of claim 6, wherein the asset is a domain name registration.

9. The system of claim 8, wherein the multilateral negotiation is an auction.

10. The system of claim 8, wherein the first message includes a URL for a bilateral negotiation website.

11. The system of claim 6, wherein the first screen includes:
an identification of the asset that was subject to the multilateral negotiation;
a countdown clock for displaying a remaining time for the first bilateral negotiation;
a current offer price;
a counteroffer section for making a counteroffer against a previous offer;
an option section for terminating the first bilateral negotiation;
a history section for displaying a history of offers; and
a list of bidders and outcomes of negotiations, the list viewable only by the seller.

12. The system of claim 11, wherein the first message includes a URL for a bilateral negotiation website.

13. The system of claim 12, wherein the asset is a domain name registration.

14. The system of claim 6, wherein participants eligible for any bilateral negotiation consist of a registrant of the domain name registration and a plurality of bidders rank ordered in accordance with values of the bidder's final bid in the multilateral negotiation.

15. The system of claim 14, wherein the first bilateral negotiation is followed by a second bilateral negotiation, each session being limited to the registrant of the domain name and one bidder.

16. The system of claim 15, wherein the multilateral negotiation is an auction.
